(19) United States
(12) Patent Application Publication
(10) Pub. No.: US 2025/0240240 A1
(43) Pub. Date: Jul. 24, 2025

(54) MACHINE LEARNING DRIVEN NETWORK TRAFFIC OBFUSCATION

(71) Applicant: SCATR, Corp., Sheridan, WY (US)

(72) Inventor: John P. KEYERLEBER, Richmond Heights, OH (US)

(21) Appl. No.: 18/421,960

(22) Filed: Jan. 24, 2024

(51) Int. Cl. H04L 45/74; H04L 69/22

(52) U.S. Cl. CPC H04L 45/74; H04L 69/22

(57) ABSTRACT

In an example, a scatter network device comprises a non-transitory memory, at least one processor, and a scatter application stored in the non-transitory memory. When executed by the at least one processor, the scatter application receives a request to transmit source data to a destination device, processes the source data via a predictive machine-learning model executed by the scatter application to packetize the source data into a data packet, the data packet having a format indicative of network traffic existing in a region in which the scatter network device is located and having a frequency of occurrence greater than a threshold amount, and transmits the data packet.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Data transmitted between two computing systems may travel via defined paths or routes, through any of a variety of publicly accessible networks (e.g., the Internet), and may use any of a variety of media, such as Ethernet or fiber cabling. In known methods of data transmission across networks, data routing is performed based on a public or an external Internet protocol (IP) address. Data packets are generally forwarded across multiple routers to the requested IP address by the fastest path available at the time of transmission, with the packet's destination visible upon inspection.

Whenever data is moved between two points, there is a potential risk of unauthorized access to that data by an eavesdropper or other unauthorized actor. Conventional techniques to secure the transmission of confidential information typically rely upon data being encrypted by a sufficiently complex single encryption algorithm or multiple encryption algorithms. For example, a virtual private network (VPN) establishes a virtual point-to-point connection (e.g., a so-called “secure tunnel”) in which data is encrypted when it leaves one location and is decrypted at its destination, where both source and destination are identified by unique, attributable IP addresses. Any intermediate stops (hops, nodes, etc.) are also identifiable by their assigned IP address.

In the scenario above, two types of unauthorized users may attempt to access the transmitted data. First, an unauthorized user with access to an applicable encryption key (e.g., an employee of the source client that generated the data or a knowledgeable malicious actor) could observe the transmission and be able to decrypt and read the entirety of the communication. Next, an unauthorized user with no access to the applicable encryption key (e.g., an eavesdropper) may not be able to read the actual content of a communication, but may still be able to derive relevant information about the data transmission merely from observation, such as one or more of its destination, its source, its intermediate hops, the relative size (number of packets) of the transmission, the transmission type (e.g., based on destination port), and the like. Either of these bad actors could observe, capture, manipulate, divert, and/or log information about these types of transmissions. What is more, even with respect to an eavesdropper that does not have an encryption key, the actual content of a transmission may not be safe indefinitely, as it is possible that a previously-accessed encrypted transmission may later become accessible. As computing resources improve, increasingly complex methods of encryption are subject to being “cracked” or broken, rendering such encryption useless. Once the encryption algorithm is broken, an adversary may be able to read unauthorized data that they previously obtained and stored.

### SUMMARY

In an example, a scatter network device comprises a non-transitory memory, at least one processor, and a scatter application stored in the non-transitory memory. When executed by the at least one processor, the scatter application receives a request to transmit source data to a destination device, processes the source data via a predictive machine-learning model executed by the scatter application to packetize the source data into a data packet, the data packet having a format indicative of network traffic existing in a region in which the scatter network device is located and having a frequency of occurrence greater than a threshold amount, wherein the format indicative of network traffic existing in the region in which the scatter network device is located is different from a format of the source data, and transmits the data packet.

In an example, a method includes receiving a training data set, the training data set including network traffic for a geographic region. The method also includes training a machine-learning model by characterizing, via a machine-learning analysis, the geographic region based on the training data set to determine first network traffic characteristics occurring in the geographic region at a frequency greater than second network characteristics. The method also includes receiving a data packet packetized according to the machine-learning model. The method also includes analyzing the data packet to determine whether the data packet exhibits suspicious characteristics. The analysis results in data packet feedback. The method also includes refining the machine-learning model based on the data packet feedback.

In an example, a method includes receiving, at a scatter network device, a request to transmit source data from a source device to a destination device. The method also includes forming a data packet including at least a source Internet Protocol (IP) address identifying the scatter network device, a deceptive destination IP address not identifying the destination device, and a payload. The payload includes at least a portion of the source data. The deceptive destination IP address identifies a network destination determined to receive a volume of communication greater than a threshold amount from a region in which the scatter network device is located. The method also includes transmitting the data packet having the deceptive destination IP address in a network.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is a block diagram of a communication system according to an example of the disclosure.

FIG. 1B is another block diagram of the communication system according to an example of the disclosure.

FIG. 2 is a block diagram of a scattering application datagram according to an example of the disclosure.

FIG. 3 is a flow chart of a method according to an example of the disclosure.

FIG. 4 is a flow chart of a method according to an example of the disclosure.

FIG. 5 is a flow chart of a method according to an example of the disclosure.

FIG. 6 is a block diagram of a computer system according to an example of the disclosure.

### DETAILED DESCRIPTION

It should be understood at the outset that although illustrative implementations of one or more examples are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The disclosure teaches a variety of elaborations and extensions of scatter networking technology. Communication between a source and a destination via the Internet or other communication network may be scattered by a collaborating pair of scatter network nodes. The source may be a first user device such as a mobile phone or a laptop computer; the destination may be a second user device such as a mobile phone or a laptop computer. Alternatively, the source may be the first user device and the destination may be a server application such as a social networking application executing on computer system or in a cloud computing environment or a financial services application executing on a computer system or in a cloud computing environment. For further details of scattering network communications and scattered data, see U.S. Pat. No. 11,153,276 B1 issued Oct. 19, 2021, titled “Secure Data Routing and Randomizing” by John P. Keyerleber, and U.S. patent application Ser. No. 18/194,413, filed Mar. 31, 2023, titled “Secure Data Routing and Randomizing with Channel Resiliency” by John G. Andrews, et al., which is hereby incorporated by reference herein in its entirety.

In some examples, an unauthorized user may make inferences, determine correlations, or otherwise glean meaningful information from the scattered data, even if that scattered data is encrypted. For example, the unauthorized user may glean meaningful information from an Internet protocol (IP) address included in, or associated with, the scattered data.

To mitigate the opportunity for the unauthorized user to determine an IP address of a destination of the scattered data, and thereby learn an identity of the sender or recipient of the scattered data, a location of the sender or recipient of the scattered data, or other information related to the sender or recipient of the scattered data, in some examples, an IP address included in a data packet including the scattered data may be spoofed. For example, the first user device may transmit the scattered data via a first of multiple available communication channels. In some examples, the first communication channel includes an intermediate hop or node at which the scattered data is processed. For example, the intermediate hop may be a mobile network operator of a cellular network through which at least a portion of the first communication channel is implemented. In another example, the intermediate hop may be a terrestrial or ground handoff station of a satellite communication network through which at least a portion of the first communication channel is implemented. In yet another example, the intermediate hop or node is a central hub, a regional aggregation hub, a regional distribution hub, or other network operations location of a wireline network provider (e.g., of a cable modem based network, a fiber based network, or the like).

For example, the first user device may prepare a data packet (e.g., the scattered data) for transmission. In various examples, the data packet may include a source IP address of the first user device, a destination IP address for the data packet, or payload. At least some portions of the data packet, such as at least some portions of the payload, may be encrypted. In some examples, the payload may be implemented as a padded uniform random blob (PURB). In some examples, the data packet may be formatted according to a User Datagram Protocol (UDP).

In an example, the destination IP address included by the first user device in the data packet may be deceptive. For example, the deceptive destination IP address may be a valid IP address which correctly identifies a device that could receive the data packet. However, the deceptive destination IP address is not representative of an actual, intended or desired destination for the data packet, as intended by the first user device. Rather, the deceptive destination IP address included in the data packet by the first user device may serve as network traffic obfuscation, obfuscating the actual, intended destination of the data packet to an unauthorized party that may intercept, monitor, or otherwise glean information from the data packet.

To facilitate routing of the data packet to a correct destination, despite that data packet including a deceptive destination IP address, Access Point Name (APN) redirection may be employed. For example, the first user device may include an application that prepares the scattered data for transmission (e.g., a scatter application). A provider of the scatter application (e.g., a scatter provider) may partner with an entity in control of the intermediate hop (e.g., a network operator), such as a mobile network operator, a satellite network operator (or the operator of a ground handoff station associated with a satellite network), or other communication provider having control over operation of at least some of the hardware of the communication network. Through this partnership, the network operator may receive and identify the data packet, and may redirect the data packet to a server of the scatter provider. Responsive to receipt of the data packet, the server of the scatter provider may determine an actual destination IP for the data packet. For example, the scatter provider may decrypt, decode, or otherwise obtain the actual destination IP for the data packet from the payload of the data packet, or based on information included in the data packet, including at least information included in the payload. In some examples, the scatter provider may determine an actual destination for the data packet based on an endpoint validation token (EVT) included in the payload and uniquely identifying the actual destination for the data packet. In some examples, the EVT includes the actual destination IP for the data packet, while in other examples the scatter provider performs a lookup to determine the actual destination IP for the data packet based on the actual destination for the data packet identified in the EVT.

While obfuscating an intended, or actual, destination for a data packet may be useful in preventing an unauthorized party from gleaning meaningful information from the data packet, it may also create circumstances that raise suspicions regarding the data packet, the source IP address, and/or the destination IP address. For example, network traffic destined for a certain destination IP address may have a customary format, such as a format that a majority of network traffic destined for the certain destination IP address may comport with. Because the data packet is not in fact destined for the destination IP address, the data packet may not have the customary format of network traffic destined for the destination IP address. As a result, an unauthorized party viewing the data packet may determine that the data packet is suspicious because its destination IP address and formatting are inconsistent with expectations of the unauthorized party. Such a circumstance may be undesirable because it may bring attention to the data packet, the source IP address, and/or the destination IP address.

To mitigate at least some of the above challenges, the first user device, such as through the scatter application, may format the data packet in a manner expected for network traffic being transmitted to the destination IP address. The format into which the data packet is formatted may be a different format that the data packet would otherwise be in, different from a format of raw data of the data packet, or the like. In some examples, this includes modifying format or content of the payload. In other examples, this includes splitting the data packet into multiple data packets each having smaller lengths. In other examples, this includes instructing the actual destination (e.g., a second user device) to send a reply to the first user device with some determined periodicity. In other examples, this includes selecting a destination IP address based on a geographic area in which the first user device is located, based on a time of day, day of week, week of month, or month of year in which the data packet is being transmitted, or the like. In this way, not only is the destination IP address obfuscated in the data packet, but the data packet itself is obfuscated, making the data packet appear to an unknowing observer as if the data packet is something other than its true nature.

To determine criteria for obfuscating the data packet, the scatter provider may characterize various geographic areas, including a geographic area in which the first user device is located. To characterize the geographic area, the scatter provider may monitor or otherwise analyze network traffic flowing into, or out of, that geographic area. For example, the scatter provider may determine what form or forms of network traffic (e.g., email, media streaming, social media, etc.) occur most frequently in the geographic area, network traffic characteristics according to time of day, day of week, etc., a record type of the network traffic, packet size of the network traffic, request/reply characteristics of the network traffic, inter-packet timing between requests and replies of the network traffic, a number of data packets in a given communication session, a volume of data packets sent by a device, or sent to a destination, in a given unit of time, bandwidth, or the like. In at least some examples, the analysis may be performed based on network and application protocol headers of the network traffic being analyzed.

In some examples, the analysis is performed via a machine-learning system, such as a system executing an artificial intelligence engine, that is capable of generating one or more predictive models. The analysis may be performed on training data, which may be captured by the scatter provider, provided to the scatter provider by the network operator, or obtained from any other suitable source. In some examples, the models may be per communication channel. For example, communication via a cellular network channel may have at least some different characteristics than communication via a satellite communication channel, each of which may have at least some different characteristics than communication via a wireline (e.g., fiber, copper, etc.) communication channel, than communication via a WiFi communication channel, and the like. In some examples, communication via a first cellular network channel may have at least some different characteristics than communication via a second cellular network communication channel, and similarly for satellite communication channels. Based on the analysis, the machine-learning system generates and provides one or more predictive, or generative, channel models.

For example, for a first communication channel (e.g., a cellular network communication channel), a protocol of network traffic, a size or length of network traffic packets, timing between network packets, and the like may be different from that of a second communication channel, such as a satellite communication channel. As such, the machine-learning system may, for each communication channel, determine multiple models for network traffic communicated via that respective communication channel. In some examples, the models include at least a protocol model, a session model, and a characterization mode. In some examples, the models may also include a routing model. The protocol model may indicate an expected, or probable, protocol of the network traffic and characteristics of the protocol such as header size, header content, inter-packet timing (e.g., an interpacket gap), record type count, and the like. The session model may indicate characteristics of a particular communication session, such as a packet length, a packet volume, and the like. In some examples, for each protocol identified in the protocol model, a separate session model may be determined. The characterization model may indicate characteristics that are regional or geographic based. For example, for a given geographic area, what protocols are used more frequently than others, what is the average length of a communication session, what network traffic types are more common than others, what is an average volume of network traffic transmitted by a single device, what is an average volume of network traffic transmitted to a single destination, how do the network traffic patterns of the geographic area vary with time of day, day of week, week of month, or month of year, and the like. The routing model may indicate for a particular type or types of network traffic, a certain destination or destinations to which the network traffic is transmitted more often than other destinations.

In some examples, the models individually, or collectively, form a generative model. The generative model may be capable of, based on the training performed by the machine-learning system based on the training data, predicting characteristics for a data packet substantially at runtime. For example, responsive to the scatter application executing on the first user device receiving a request to scatter and transmit source data, the generative model may packetize the source data (or a portion of the source data, after division by the scatter application). The generative model may perform the packetization based on the determined models for network traffic, described above, to form a scatter packet, such that for a particular time of day, the network traffic has characteristics that are within a programmed standard deviation of average, or common, characteristics for network traffic for the geographic area in which the first user device is located. In some examples, the generative model determines which communication channel of multiple communication channels available to the first user device is most suitable for sending the data packet, as well as determining characteristics for the data packet. In other examples, the scatter application informs the generative model which communication channel will be used to transmit the data packet, and the generative model determines characteristics for the data packet.

In some examples, source data is separated into multiple portions which are each packetized for transmission. In other examples, multiple pieces of source data are handled substantially simultaneously. To handle the multiple data packets, in some examples, each communication channel may be associated with a queue. In this way, data packets for transmission by the first user device may be queued for transmission, where a timing between transmissions on each communication channel, and among the communication channels, may be controlled based on predictions of the generative model. For example, a single source data may be divided into multiple packets which are sent across multiple communication channels (e.g., channels A, B, and C). In some examples, transmission may rotate among the channels, first with channel A, then channel B, then channel C, and returning to channel A until all data to be transmitted has been transmitted. In other examples, such as rotation may not comport with the predicted characteristics for the data packets, as predicted by the generative model. As such, the transmission may be modified to control bandwidth, record type count, inter-packet timing, request/reply pairs, or any other suitable characteristic. For example, the transmission may rotate among the channels, first with channel A, then channel B, then again with channel B, then channel C, then with channel B, and returning to channel A (or any other suitable mix and rotation of channel selections) until all data to be transmitted has been transmitted.

As described above, in some examples, the generative model packetization of data to form a data packet for transmission, and the use of a deceptive destination IP address, may be combined to form a multi-layered network traffic obfuscation scheme. In this way, a malicious or unauthorized party intercepting the network traffic may be limited in what useful information the party may gain from the network traffic. In some examples, resulting from one or both layers of the network traffic obfuscation described herein, the network traffic may not even raise suspicions of the unauthorized party to cause the unauthorized party to examine the network traffic.

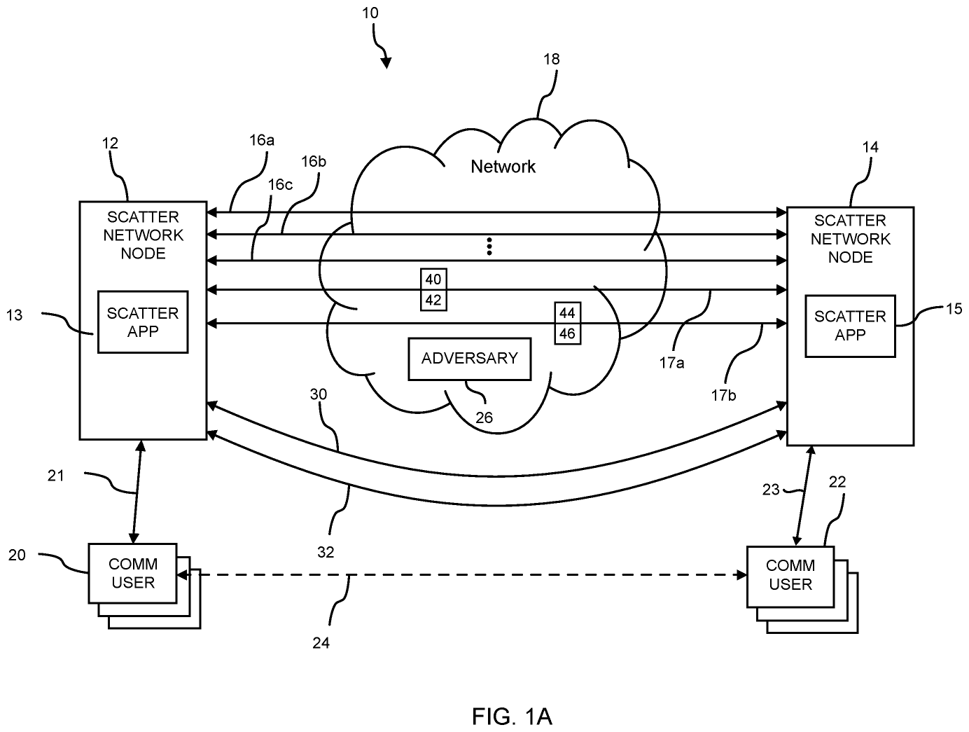

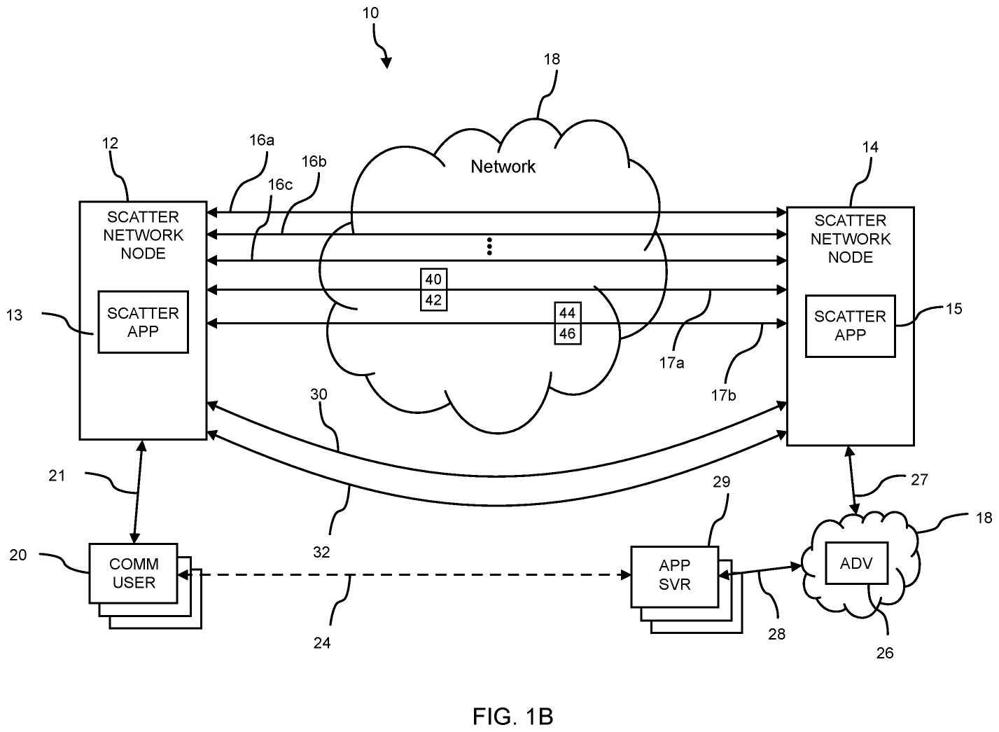

Turning now to FIG. 1A, a communication system 10 is described. In an example, the system 10 comprises a first scatter network node 12 that executes a first scattering application 13 and a second scatter network node 14 that executes a second scattering application 15. In an example, the first scattering application 13 is a first instance and the second scattering application 15 is a second instance of the same scattering application. In another example, however, the first scattering application 13 may be different from the second scattering application 15, for example the first scattering application 13 may be configured to play a client role while the second scattering application 15 may be configured to play a server role.

The scatter network node 12 and the scatter network node 14 may each be implemented as separate computer systems, for example server computers. Computer systems are described further hereinafter. One or both of the scatter network nodes 12, 14 may be implemented as a smart phone, a wearable computer, a headset computer, a laptop computer, a tablet computer, a notebook computer, or an Internet of Things (IoT) device having at least some functionality of a computer. One of the scatter network nodes 12, 14 may be implemented as one or more virtual servers executing in a cloud computing environment.

The scattering applications 13, 15 comprise executable logic instructions that comprise scripts, compiled high-level language code, assembly language instructions, and/or interpreted language code. The scattering applications 13, 15 may be provided as shell scripts, compiled C language code, compiled C++ language code, JAVA code, and/or some other kind of logic instructions. In an example, compiled C language code is used to implement the logic instructions of the scattering applications 13, 15 and provides access to operating system calls and greater control of the operations on the scatter network nodes 12, 14 than scripts may provide. The scattering applications 13, 15 may also comprise data such as configuration data and/or provisioning data, for example provisioning data that defines logical communication channels, associations of user devices to logical communication channels, instructions for forming encryption keys, such as asymmetric encryption keys, an ephemeral key, a private key, or the like, and instructions for performing a key exchange.

In an example, the scatter network nodes 12, 14 collaborate with each other to establish a plurality of logical communication channels 16 by which they communicate with each other via a network 18. The network 18 may comprise one or more private networks, one or more public networks, or a combination thereof. In an example, the network 18 comprises the Internet. FIG. 1A shows a first logical communication channel 16a, a second logical communication channel 16b, and a third logical communication channel 16c, but it is understood that the scatter network nodes 12, 14 may establish any number of logical communication channels 16, for example 2, 3, 4, 5, 6, 7, 8, 9, 10, 15, 16, 20, 25, 27, 30, 32, 64, 138, 256, 1024, 4096, or some other greater number of logical communication channels 16.

Each logical communication channel 16 may comprise a data communication link that may be considered as an IP communication path. Each logical communication channel 16 is bidirectional such that data packets may flow from the first scatter network node 12 to the second scatter network node 14 via the logical communication channels 16, and data packets may flow from the second scatter network node 14 to the first scatter network node 12 via the logical communication channels 16. Each logical communication channel 16 may pass through various network nodes within the network 18. As discussed further hereinafter, some of the network nodes that the logical communication channels 16 pass through may include simple scatter relays and/or advanced scatter relays. The data communication passing from the first scatter network node 12 to the second scatter network node 14 or vice versa from the second scatter network node 14 to the first scatter network node 12 is treated within the network 18 as IP datagrams.

In an example, the communication between the first scatter network node 12 and the second scatter network node 14 is encrypted. For example, a data portion of an application datagram encapsulated in a data portion of the IP datagrams may be encrypted. For example, a data portion of an application datagram and selected parts of a header portion of the application datagram encapsulated in the data portion of the IP datagrams may be encrypted. In some examples, the encryption may cause the encrypted portions of the communication to take on a pseudorandom appearance such that the encrypted portions of the communication may be indistinguishable from random noise. In some examples, the encryption may cause the encrypted portions of the communication to become, or be formatted as, a padded uniform random blob (PURB), or data packets that are indistinguishable from random noise.

In an example, the communication between the first scatter network node 12 and the second scatter network node 14 may be considered to flow over a VPN. In some contexts, the scatter network nodes 12, 14 may be said to establish a scatter network via the logical communication channels 16.

A first communication user device 20 may establish a first local communication link 21 with the first scatter network node 12. A second communication user device 22 may establish a second local communication link 23 with the second scatter network node 14. The communication user devices 20, 22 may desire to communicate with each other via an application layer link 24 that is implemented via the scatter network nodes 12, 14 that provide network layer communication links (IP datagram traffic) via the network 18. Note that the dotted line 24 indicates that the application layer link is conceptual in nature and that the actual communication path between the communication user devices 20, 22 passes through the scatter network nodes 12, 14 and the network 18. The first and second local communication links 21, 23 may be insecure and may not carry encrypted data packets. For example, the IP datagrams sent by the first communication user device 20 may designate the true IP address of the first communication user device 20, and the IP datagrams sent by the second communication user device 22 may designate the true IP address of the second communication user device 22. It is undesirable to send IP datagrams that include the true IP addresses of communication user devices 20, 22 via the network 18 because an adversary system 26 may be sniffing or otherwise monitoring the data traffic in the network 18 and identify these user devices 20, 22. The scatter network nodes 12, 14 hide the true IP addresses of the communication user devices 20, 22.

To establish a communication link with a scatter node, such as the first communication user device 20 establishing the first local communication link 21 with the first scatter network node 12 or the second communication user device 22 establishing the second local communication link 23 with the second scatter network node 14, the communication user device 20, 22 performs a key exchange with the scatter network node. The key exchange may be performed out of band. For example, the first scatter network node 12 may establish a first out of band link 30 with the second scatter network node 14. In some examples, the first scatter network node 12 may establish a second out of band link 32 with the second scatter network node 14. In other examples, the second scatter network node 14 may establish the second out of band link 32 with the first scatter network node 12. Although shown as outside the network 18, in some examples one or both of the first out of band link 30 and/or the second out of band link 32 may traverse the network 18 while remaining separate and distinct from the logical communication channels 16. In some examples, the adversary 26 may be unaware of, or unable to monitor or intercept key exchange information performed via the first out of band link 30 and/or the second out of band link 32 between the first scatter network node 12 and the second scatter network node 14. However, even if the adversary 26 intercepts the key exchange information performed via the first out of band link 30 and/or the second out of band link 32, because the key exchange information is performed out of band (e.g., not via the logical communication channels 16), the adversary 26 may lack sufficient information to correlate that key exchange information to communication of the first scatter network node 12 or the second scatter network node 14 performed via the logical communication channels 16.

In some examples, the communication system 10 includes at least some APN redirection capable logical communication channels 17. FIG. 1A shows a first APN redirection capable logical communication channel 17a and a second APN redirection capable logical communication channel 17b, but it is understood that the scatter network nodes 12, 14 may establish any number of logical communication channels 17, for example 2, 3, 4, 5, 6, 7, 8, 9, 10, 15, 16, 20, 25, 27, 30, 32, 64, 138, 256, 1024, 4096, or some other number of logical communication channels 16 less than 2 million logical communication channels. In some examples, an APN redirection capable logical communication channel is a logical communication channel between the scatter network node 12 and the scatter network node 14, and has an intermediate or relay network node that includes, or is communicatively coupled to a scatter relay. For example, the first APN redirection capable logical communication channel 17a may exist between the scatter network nodes 12, 14 and have an intermediary network node 40. The intermediary network node 40 may be, for example, a mobile network operator (or server of a mobile network operator) such that at least a portion of the APN redirection capable logical communication channel 17a is a cellular communication channel. The intermediate network node 40 may be co-located with, include, or otherwise be communicatively coupled with a scatter relay 42. In another example, the, the second APN redirection capable logical communication channel 17b may exist between the scatter network nodes 12, 14 and have an intermediary network node 44. The intermediary network node 44 may be, for example, a ground handoff station (or server of a ground handoff station) for a satellite communication channel such that at least a portion of the APN redirection capable logical communication channel 17b is a satellite communication channel. The intermediate network node 44 may be co-located with, include, or otherwise be communicatively coupled with a scatter relay 46.

In some examples, the scatter network node 12 communicates with the intermediate network node 40 to identify and register with the intermediate network node 40. As an element of this registration, the scatter network node 12 may provide identifying information to the intermediate network node 40, such as a media access control address of the scatter network node 12. The scatter relay 42 may inform the intermediate network node 40 that the scatter network node 12 is to be registered for APN redirection. As such, the intermediate network node 40 may register an association between an IP address assigned by the intermediate network node 40 to the scatter network node 12 and an APN redirection to the scatter relay 42. As such, responsive to the intermediate network node 40 receiving a data packet from the scatter network node 12, the intermediate network node 40 may disregard a destination IP address (e.g., an IP address indicating a destination other than the scatter network node 14) indicated in the data packet and instead provide the data packet to the scatter relay 42.

The scatter relay 42 processes the data packet, replacing the destination IP address (which may be deceptive), with an actual destination IP address, each as described above. The scatter relay 42 may determine the actual destination IP address based on contents of the data packet, such as an EVT included in the data packet, contents of a payload of the data packet, a source IP address of the data packet, the destination IP address of the data packet, a lookup table maintained by or accessible to the scatter relay 42, or any combination thereof. In some examples, the scatter relay 42 provides the processed data packet back to the intermediate network node 40 for transmission on through the network 18 to the scatter network node 14. In other examples, the scatter relay 42 itself transmits the processed data packet on through the network 18, such as via one or more other logical communication channels 16, or private communication channels (not shown) to the scatter network node 14.

In some examples, the first scatter network node 12, such as implemented by the first scattering application 13, includes machine-learning (e.g., artificial intelligence) functionality. For example, the first scattering application 13 may form at least some data packets for transmission to the second scatter network node 14, whether via the logical communication channels 16 or the APN redirection capable logical communication channels 17, through implementation of the machine-earning functionality. For example, the first scattering application 13 may generate, or receive from another device (not shown) one or more predictive models. Each predictive models may be specific to a respective one of the logical communication channels 16 or the APN redirection capable logical communication channels 17. For example, for each of the logical communication channels 16 or the APN redirection capable logical communication channels 17, one or more predictive models may be generated describing protocol characteristics, as described above, common for network traffic in a region in which the scatter network node 12 is located. Similarly, for each of the predictive models describing protocol characteristics, predictive models may be generated describing communication session characteristics, also as described above, common for network traffic in the region in which the scatter network node 12 is located and for a particular communication protocol. Still further, one or more models may be generated describing general characteristics, also as described above, common for network traffic in the region in which the scatter network node 12 is located.

Based on these predictive models, the first scattering application 13 may generate a data packet for transmission. For example, the first scattering application 13 may receive data from the communication user device 20 for transmission by the scatter network node 12. Responsive to receiving the communication, the first scattering application 13 processes the data to separate the data to form multiple pieces of scattered data, and then packetizes the scattered data into data packets for transmission. In at least some examples, the packetization is performed based on one or more of the predictive models. For example, based on the predictive model(s), a protocol header of the data packet(s) may be generated or modified, such as to include a particular identifying code for the data packet, a particular record type for the data packet, a particular protocol type for the data packet, a size of the protocol header, or the like. Further based on the predictive model(s), a size of the data packet may be modified, such as by padding the data packet with noise or other non-useful data, or separating the data packet into multiple data packets. Further based on the predictive model(s), a timing for transmitting the data packet may be controlled, such as based on time of day, based on bandwidth consumed, based on a volume of previously transmitted data packets, or previously transmitted data packets having certain characteristics, or the like. In this way, the data packets may be obfuscated, and generated or modified pursuant to the predictive model(s) to simulate types of network traffic other than what is reflected by the actual contents of the data packet. For example, based on the obfuscation pursuant to the predictive model(s), the first scattering application 13 may cause video streaming data to appear to an observer as if it were a request to check an email account for new messages. Similarly, based on the obfuscation pursuant to the predictive model(s), the first scattering application 13 may secure VPN network traffic to appear to an observer as if it were non-secure social media traffic. Generally, based on the obfuscation pursuant to the predictive model(s), the first scattering application 13 may hide or obscure a true nature of network traffic transmitted by the scatter network node 12, causing the network traffic to have one or more contrived characteristics determined through machine-learning to be common in the region in which the scatter network node 12 exists.

In some examples, the first scattering application 13 creates and maintains queues for one or more of the logical communication channels 16 and/or the APN redirection capable logical communication channels 17. In such examples, data packets for transmission by the first scatter network node 12 may be queued for transmission via respective logical communication channels 16 or APN redirection capable logical communication channels 17 based on determinations made by the predictive model(s) of the first scattering application 13, other communication rules of the first scattering application 13, or user input provided by the communication user device 20. In some examples, an order in which the first scattering application 13 pulls data packets off the queue(s) for transmission may be controlled based on the predictive model(s). For example, the predictive model(s) may provide an inter-packet timing, a packet volume limit, a bandwidth limit, or other characteristics for use with each respective logical communication channels 16 and APN redirection capable logical communication channels 17, thereby controlling an order and timing with which the first scattering application 13 pulls a data packet off of one of the the queue and transmits the data packet via a corresponding one of the logical communication channels 16 or APN redirection capable logical communication channels 17.

In some examples, it may be considered suspicious for the first scatter network node 12 to transmit a particular volume of network traffic, or to transmit network traffic in a particular communication session or of a particular protocol, without receiving a certain threshold number of replies, or replies having particular timings with respect to transmitted data packets. To mitigate the occurrence of these suspicious circumstances, at least some data packets transmitted by the first scatter network node 12 may include an instruction for a receiving device (such as the second scatter network device 14 or the scatter relay 42) to transmit a reply to the first scatter network node 12. In some examples, the instruction includes additional instructions for characteristics or other details of the reply transmission, while in other examples the instruction merely causes the other device to perform the reply transmission using characteristics at its own discretion. In at least some examples, the predictive model(s) implemented by the first scattering application 13 specify which data packets include the instructions to cause the receiving device to transmit a reply message.

In some examples, the first scattering application 13 may determine a destination IP address (such as a deceptive destination IP address, as described above) for the data packet based on the predictive models. For example, the first scattering application 13, via the predictive models, may determine that for a particular time of day, day of week, week of month, or month of year, a particular protocol type, a particular message type, a particular communication session, or the like, a destination IP address that is more common for that type of network traffic in the region in which the scatter network node 12 is located than other destination IP addresses. Thus, to further aid in the network traffic obfuscation of the first scatter network node 12 and the first scattering application 13, the determined destination IP address may be used with the data packet. As described above, the data packet may be redirected from the destination IP address included in the data packet to an actual destination IP address via APN redirection performed by the scatter relay 42 when the data packet is transmitted over an APN redirection capable logical communication channel 17.

In some examples, the first scattering application 13 includes a network monitoring function. The network monitoring function may be implemented at least in part via the machine-learning functionality of the first scattering application 13. The network monitoring function may monitor outgoing network traffic of the first scatter network node 12. In other examples, the network monitoring function is alternatively, or additionally as a second (or subsequent) instance, implemented by one or more scatter relays (not shown) disposed along the logical communication channels 16 or APN redirection capable logical communication channels 17, or by the second scatter network node 14. The network monitoring function may monitor the outgoing network traffic of the first scatter network node 12 (or in the case of the second scatter network node 14, the incoming network traffic from the first scatter network node 12), to determine feedback indicating whether the network traffic exhibits suspicious characteristics. The suspicious characteristics may include, for a given period of time or irrespective to time, a volume that exceeds a predefined threshold, a record type count that exceeds a predefined threshold, a lack of variation in packet size, too much variation in packet size, an inter-packet timing that is too short or too long in duration, a number of packets in a session that is too few or too many, too much bandwidth usage for a particular time of day, or the like. Based on the feedback, the first scattering application 13, or another device that generated and provided the predictive model(s) to the first scattering application 13, may retrain or refine the predictive model(s) via machine-learning processing (e.g., retrain or refine the training of the machine-learning process). In at least some examples, retraining or refining the predictive model(s) based on the feedback reduces the probability of network traffic transmitted by the first scatter network node 12 exhibiting the suspicious characteristics identified in the feedback, improving performance of the first scattering application 13 and first scatter network node 12.

Turning now to FIG. 1B, an alternate view of the communication system 10 is described. The communication functionality provided by the scatter network nodes 12, 14 is general and applies to other communication scenarios than that illustrated and described with reference to FIG. 1A. Note that the network 18 is shown as two cloud images in FIG. 1B but these two clouds conceptually refer to the same network. It is illustrated in FIG. 1B to facilitate understanding of flow of communications. In FIG. 1B, the communicating end users may be considered to be the first communication user device 20 and an application server 29. Thus, the first communication user device 20 may communicate with the application server 29 via an application layer communication link 24 that is conceptual in nature. The first communication user device 20 may request content from and receive content from the application server 29 or send content to the application server 29 conceptually over the application layer communication link 24 but in fact via the first communication link 21, via the logical communication channels 16, via a third communication link 27 to the network 18, and from the network 18 via a fourth communication link 28 to the application server 29. It will be appreciated that the network 18 through which the logical communication channels 16 and the APN redirection capable logical communication channels 17 route is the same network 18 through which the second scatter network node 14 communicates with the application server 29 via communication links 27, 28, drawn separately here to support further understanding of the system 10.

As illustrated in FIG. 1B, the adversary 26 may be located so as to monitor communication between the network 18 and the application server 29. The adversary 26 may determine the true IP addresses of a communication port of the second scatter network node 14 and a communication port of the application server 29. Importantly, however, the adversary 26 is not able to determine the true IP address of the first scatter network node 12 or of the first communication user device 20, hence the adversary 26 is not readily able to determine an approximate location of the first communication user device 20 and/or of the first scatter network node 12. As described above with respect to FIG. 1A, the adversary 26 may be unaware of, or unable to monitor or intercept key exchange information performed via the first out of band link 30 and/or the second out of band link 32 between the first scatter network node 12 and the second scatter network node 14.

With reference now to both FIG. 1A and FIG. 1B, the first logical communication channel 16a may be considered to be defined by an IP address and port number at the first scatter network node 12 and an IP address and port number at the second scatter network node 14. The term port number or port numbers refers to a transport communication layer port number or transport communication layer port numbers and may include well-known port numbers, such as Transmission Communication Protocol (TCP) port numbers or UDP port numbers. In an example, the first scatter network node 12 and/or the first scattering application 13 may define sockets to establish the communication ports at its end of the logical communication channels 16, and the second scatter network node 14 and/or the second scattering application 15 may define coordinate sockets to establish the communication ports at its end of the logical communication channels 16. Sockets are a well-known communication abstraction used for conducting data communication between computer systems over the Internet. In an example, the sockets may be UDP type sockets. In an example, the sockets may be TCP type sockets. In an example, a different intermachine communication abstraction may be used to implement the logical communication channels 16.

The first logical communication channel 16a is bidirectional: in a first communication event, the first scatter network node 12 may send an IP datagram via the first logical communication channel 16a to the second scatter network node 14 via the network 18, while in a second communication event, the second scatter network node 14 may send an IP datagram via the first logical communication channel 16a to the first scatter network node 12 via the network 18. The different logical communication channels 16 connect to the first scatter network node 12 at a different pair of IP address port number values. For example, the first logical communication channel 16a may connect to the first scatter network node 12 at a first IP address and first port number; the second logical communication channel 16b may connect to the first scatter network node 12 at a second IP address and the first port number; and the third logical communication channel 16c may connect to the first scatter network node 12 at a third IP address and the first port number.

Alternatively, the first logical communication channel 16a may connect to the first scatter network node 12 at a first IP address and first port number; the second logical communication channel 16b may connect to the first scatter network node 12 at the first IP address and a second port number; and the third logical communication channel 16c may connect to the first scatter network node 12 at the first IP address and a third port number. Alternatively, the first logical communication channel 16a may connect to the first scatter network node 12 at a first IP address and first port number; the second logical communication channel 16b may connect to the first scatter network node 12 at a second IP address and the first port number; and the third logical communication channel 16c may connect to the first scatter network node 12 at a third IP address and a second port number. The logical communication channels 16 may attach to the second scatter network node 14 by other combinations of IP address/port number pairs.

It is noted that a logical communication channel 16 may be defined by any unique combination of: (A) an IP address associated with the first scatter network node 12, (B) a port number at the first scatter network node 12, (C) an IP address associated with the second scatter network node 14, and (D) a port number at the second scatter network node. Thus, the first logical channel 16a could be defined by a first IP address associated with the first scatter network node 12, a first port number at the first scatter network node 12, a second IP address associated with the second scatter network node 14, and a second port number at the second scatter network node 14; the second logical channel 16b could be defined by the first IP address associated with the first scatter network node 12, the first port number at the first scatter network node 12, a third IP address associated with the second scatter network node 14, and the second port number at the second scatter network node; and the third logical channel 16c could be defined by the first IP address associated with the first scatter network node 12, the first port number at the first scatter network node 12, the second IP address associated with the second scatter network node 14, and a third port number at the second scatter network node 14. These are examples of unique IP addresses and port numbers that uniquely define logical communication channels 16, but it is understood there are many alternative combinations.

The first out of band link 30 and/or second out of band link 32 may be implemented via separate physical interfaces than are other logical communication channels or communication links of the communication system 10. For example, the first out of band link 30 and second out of band link 32 are separate and distinct from the logical communication channels 16 and the APN logical communication channels 17. As described above, some examples of physical interfaces include WiFi physical interfaces, Bluetooth physical interfaces, LTE physical interfaces, 5G wireless physical interfaces, WLAN physical interfaces, Ethernet physical interfaces, and/or satellite wireless physical interfaces (wireless interfaces linking to satellites located in space—either LEO satellites, geosynchronous satellites, or other satellites). Different physical interfaces may also include LoWPAN, BLE, GSM, LoRa, LTE-M, LTE-MTC, NB-IoT, NFC, WiFi Direct, Z-Wave, and/or Zigbee wireless physical interfaces. Examples of data bands, or communication protocols that may be utilized in performing out of band key exchange via one or more of the above physical interfaces, include short message service (SMS), mobile SIM management messages, such as USSD or USSI, etc. In some examples, one or more of the first out of band link 30 and/or second out of band link 32 are implemented via a same physical interface and/or same data band or communication protocol. In other examples, one or more of the first out of band link 30 and/or second out of band link 32 are implemented via different physical interfaces and/or data bands or communication protocols. Additionally, in some examples, the second out of band link 32 does not exist.

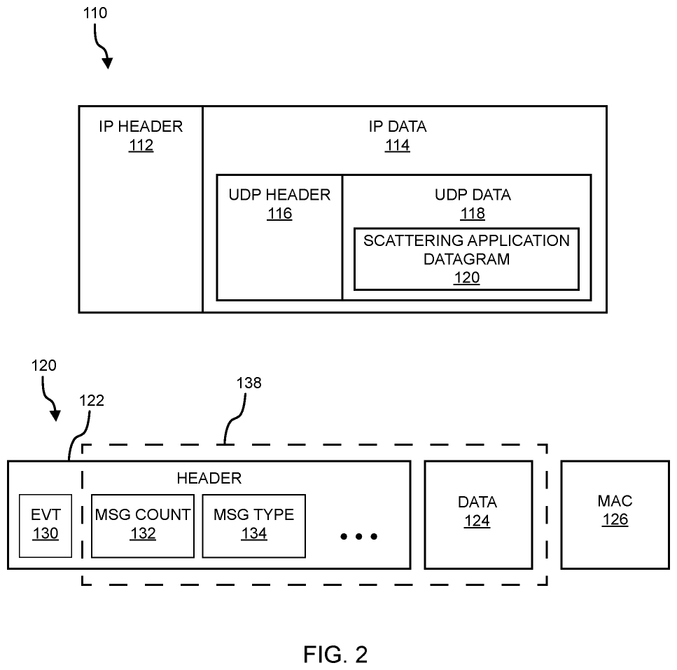

Turning now to FIG. 2, a scattering application datagram 120 is described. In an example, the messages exchanged by scatter network nodes 12, 14 each comprise a scattering application datagram 120. In an example, the scattering application datagram 120 is encapsulated as a UDP data portion 118 of a UDP datagram that also comprises a UDP header 116. The UDP datagram itself is encapsulated in an IP data portion 114 of an IP datagram 110 that also comprises an IP header 112. In another example, although not shown in FIG. 2, the scattering application datagram 120 may be encapsulated in a TCP data portion in a TCP segment, and the TCP segment may be encapsulated in the IP data portion 114 of the IP datagram 110.

In an example, the scattering application datagram 120 comprises a scattering application datagram header 122, a scattering application datagram data portion 124, and a scattering application datagram message authentication code (MAC) 126. Note that the scattering application datagram data portion 124 may be called the scattering application datagram payload, that the UDP data portion 118 may be called the UDP payload, and the IP data portion 114 may be referred to as the IP payload in some contexts. In like manner, a TCP data portion may be referred to as a TCP payload in an example where the TCP transport layer protocol is used instead of the UDP transport layer protocol. In an example, the scattering application datagram header 122 comprises an EVT 130, a message count 132, and a message type 134. It is understood that the scattering application datagram header 122 may comprise additional parameters, for example parameters that contain metadata about the scattering application datagram 120 or the logical communication channels 16.

The scattering application datagram data portion 124 comprises the actual data content that is to be conveyed between the communication user devices 20, 22 or between the first communication user device 20 and the application server 29. In an example, a portion of the scattering application datagram header 122 and all of the scattering application datagram data portion 124 are encrypted in an encrypted portion 138. In some examples, the encrypted portion 138 is a PURB. In other examples, the scattering application datagram 120 may be considered a PURB. In some examples, the encrypted portion 138, such as the scattering application datagram data portion 124, may be padded by dummy data to reach a programmed data length, for example, to obfuscate the true nature of the encrypted portion 138, scattering application datagram header 122, the scattering application datagram data portion 124, and/or the scattering application datagram 120. In an example, the message count 132 and the message type 134 parameters of the scattering application datagram header 122 as well as the scattering application datagram data portion 124 are encrypted. It is understood that the positional order of parameters in the scattering application header 122 may be different in different examples, although it may be preferred that the EVT 130 be at the front of the scattering application datagram header 122, separate from the encrypted portion 138 of the scattering application datagram 120. In other examples, the EVT 130 may instead be at the end of the scattering application datagram header 122, at some programmed location between the front and the end of the scattering application datagram header 122, or any other suitable location in the scattering application datagram 120.

The EVT 130 uniquely identifies a device (e.g., the scattering network nodes 12, 14) that sends a given scattering application datagram 120 on a logical communication channel 16. The EVT 130 permits the counterpart (e.g., receiving) device to look-up an appropriate decryption key stored in a transitory memory (e.g., random access memory (RAM)) of the counterpart device and decrypt the encrypted portion 138. The scattering application datagram MAC 126 provides a cryptographic checksum that can be used by the counterpart device to determine if the scattering application datagram 120 has been altered. The scattering application datagram MAC 126 may be calculated as a kind of hash or checksum calculated over the encrypted portion 138 based in part on using the selected encryption key. If the scattering application datagram MAC 126 does not match the MAC calculated by the scattering application 13, 15, the entire scattering application datagram 120 may be discarded as corrupted. In this case, the scattering application 13, 15 does not decrypt the encrypted portion 138. The scattering application datagram MAC 126 may be at least 6 bytes long, at least 8 bytes long, at least 10 bytes long, at least 12 bytes long, at least 14 bytes long, at least 16 bytes long, at least 18 bytes long, at least 20 bytes long, at least 22 bytes long, at least 24 bytes long and less than 129 bytes long. In some examples, the EVT 130 is selected from among multiple EVTs. For example, in a key exchange process, multiple EVTs may be provided to a device to identify the device. Each EVT may be single use, or may be limited use, such that the device changes EVTs with each new transmission, or after a programmed period of time. The device may obtain additional EVTs responsive to subsequent key exchange requests, such as when renewing an encryption key for encrypting the encrypted portion 138.

The message count 132 is a count of scattering application datagrams 120 sent by a device to a given counterpart device. The scattering application 13, 15 may keep a local count value as it sends scattering application datagrams 120 and build this into the message count 132. In an example, the message count 132 may be 4 bytes, 5 bytes, 6 bytes, 7 bytes, 8 bytes, 9 bytes, 10 bytes, 12 bytes, or some other number of bytes less than 24 bytes. As discussed further herein after, the receiving scattering application 13, 15 may use the message count to reorder received messages carried in the data portion 124 of the scattering application datagram 120 before forwarding on to the communication user device 20, 22 or to the application server 29. The message type 134 may indicate a type of the message carried in the data portion 124 of the scattering application datagram 120. The message type 134 may indicate that the message is an encryption key rotate command, is a data message (e.g., data relevant to the communication user devices 20, 22 or to the application server 29), or some other type of message.

The scattering applications 13, 15 are preconfigured to associate traffic on the logical communication channels 16 with the communication user devices 20, 22. For example, the first scattering application 13 is preconfigured to associate IP datagrams received on logical communication channels 16 to the first communication user device 20 (e.g., to the true IP address of the first communication user device 20) and to associate IP datagrams addressed to the true IP address of the second communication user device 22 to the logical communication channels 16. For example, the second scattering application 15 is preconfigured to associate IP datagrams received on the logical communication channels 16 to the second communication user device 22 (e.g., to the true IP address of the second communication user device 22) and to associate IP datagrams addressed to the true IP address of the first communication user device 20 to the logical communication channels 16. In other words, the communication user devices 20, 22 communicate in terms of their own true IP addresses, but the scatter network nodes 12, 14 hide these true IP addresses from the network 18 by means of the logical communication channels 16 which do not use the true IP addresses of the communication user devices 20, 22.

The first scatter network node 12 and the second scatter network node 14 may provide a plurality of different physical interfaces which are used to implement the logical communication channels 16, first out of band link 30 and/or second out of band link 32. These different physical interfaces may comprise one or more Ethernet physical interfaces, one or more WLAN physical interfaces, and one or more wireless wide area network (WWAN) physical interfaces, one or more satellite communication physical interfaces. The WLAN physical interfaces may comprise a WiFi physical interface and/or a Bluetooth physical interface. The WWAN physical interfaces may comprise a 6G wireless telecommunication protocol physical interface, a 5G wireless telecommunication protocol physical interface, a LTE wireless telecommunication protocol physical interface, a code division multiple access (CDMA) wireless telecommunication protocol physical interface, and/or a GSM wireless telecommunication protocol physical interface. Different physical interfaces may include 6LoWPAN, Bluetooth, BLE, GSM, LoRa, LTE, LTE-M, LTE-MTC, NB-IoT, NFC, WiFi Direct, Z-Wave, and/or Zigbee wireless physical interfaces. The satellite communication physical interface may comprise an Ethernet-to-satellite physical interface (e.g., a dongle device that uses an Ethernet connector to couple to a computer system and acts as a satellite wireless base station). The physical interfaces provided by the first scatter network node 12 may be different from the physical interfaces provided by the second scatter network node 14. By employing different physical interfaces to implement the logical communication channels 16, channel diversity may be increased and may help to further thwart attempts by the adversary system 26 to eavesdrop or monitor communications between the communication user devices 20, 22. Further, by using different physical interfaces to implement the logical communication channels in comparison to the first out of band link 30 and/or second out of band link 32, computational efficiency is increased resulting from a physical interface employing only one of symmetric encryption or asymmetric encryption and security is enhanced by separating key-exchange information from subsequent data transport, or authenticated message, transmission.

In an example, the scattering applications 13, 15 provide VPN communication functionality over the logical communication channels 16. Unlike some VPN off-the-shelf tools, the VPN communication functionality provided by the scattering applications 13, 15 does not indicate the functionality in their headers. For example, some off-the-shelf VPN tools provide an indication in their headers that a message may be a set-up type of VPN data packet, a key exchange type of VPN data packet, and user data type of VPN data packets. It is undesirable to “tip the hand” of the VPN communication traffic, as this may give an advantage to the adversary system 26, for example allowing them to focus their effort on trying to extract encryption keys from the key exchange type of VPN data packets.

Accordingly, in some examples a portion of the scattering application datagram header 122 and all of the scattering application datagram data portion 124 are encrypted as encrypted portion 138 in the form of a PURB. In other examples, the scattering application datagram 120 may be considered a PURB. The PURB is indistinguishable from random noise or random data, and may be padded with dummy data to obfuscate an actual data length of the scattering application datagram header 122, the scattering application datagram data portion 124, and/or the scattering application datagram 120. In some examples, encrypting the encrypted portion 138, or the scattering application datagram 120, in the form of a PURB facilitates advanced traffic obfuscation, such as steganography. For example, the scattering application datagram 120, including the encrypted portion 138, may be configured to mimic other types of netflow data traffic, or other data objects. For example, the scattering application datagram 120 may be embedded in an image, a webpage, a status message, an unused field or portion of a field of an unrelated data packet, etc. In this way, the scattering application datagram 120 may blend in with other network communication traffic without tipping the hand or otherwise raising warnings that the scattering application datagram 120 is encrypted or is an element of VPN communication traffic. In this way, the existence of the VPN communication traffic, and indeed the existence of encrypted communication traffic, may be obfuscated, increasing protection from the adversary system 26.

In an example, the IP header 112 includes at least a source IP address (e.g., an IP address of a device transmitting the IP datagram 110) and a destination IP address (e.g., an IP address to which the device transmitting the IP datagram 110 is transmitting the IP datagram 110). As described above, in some examples, the destination IP address is deceptive. For example, an ultimate, or actual destination for the IP datagram may have an IP address of 2.2.2.2. However, the IP header 112, when first transmitted, such as by the first scatter network node 12, may indicate a destination IP address of 4.4.4.4. An intermediary device, such as the intermediate network node 40, may receive the IP datagram 110 and identify, based on the source IP address, the MAC 126, or other characteristics of the IP datagram 110, that the IP datagram 110 is to be handled according to APN redirection. In such an example, the intermediate device provides the IP datagram 110 to a scatter relay, such as the scatter relay 42. The scatter relay 42, based on contents of the IP datagram 110, including one or more of the IP header 112, the UDP header 116, the scattering application datagram 120, the EVT 130, or any other suitable portion of the IP datagram 110, determines that rather than the stated (and deceptive) destination IP address of 2.2.2.2, the actual destination IP address for the IP datagram 110 should be 4.4.4.4. In such an example, the scatter relay may replace the deceptive destination IP address of 2.2.2.2 in the IP header 112 with the actual destination IP address of 4.4.4.4. Subsequently, the IP datagram 110 may be transmitted by the scatter relay or the intermediary device along any suitable logical communication channel to a device having the actual destination IP address of 4.4.4.4.

Further, as described above, in some examples at least some portions of the IP datagram 110 may be formed by one or more machine-learning based predictive models. For example, any one or more components of the UDP header 116 and/or the UDP data 118, as well as a rate of transmission of the IP datagram 110 in relation to other IP datagrams, a logical communication channel on which the IP datagram 110 is transmitted, or the like may be controlled or modified by one or more machine-learning based predictive models, as described above. In this way, the UDP header 116 and/or the UDP data 118 may be modified to obfuscate a true nature of the IP datagram 110, making the IP data 114 appear as common, customary network traffic for a region in which a device transmitting the IP datagram 110 is located.

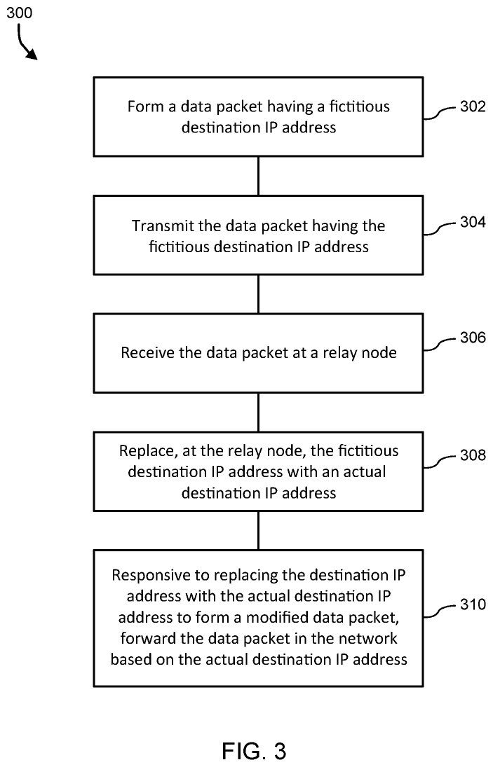

Turning now to FIG. 3, a method 300 is described. In some examples, the method 300 is a method of network traffic obfuscation. In some examples, the network traffic obfuscation is performed by at least some components of the communication system 10, such as scatter networking nodes.

At operation 302, a data packet is formed having a deceptive destination IP address. In some examples, the data packet is, or includes, an IP datagram, such as the IP datagram 110 described above with respect to FIG. 2. In an example, the deceptive destination IP address is determined based on a region in which a device transmitting the data packet is located. For example, the deceptive destination IP address may be an address determined to be a frequently occurring destination for network traffic in the region. In some examples, the determination is made by a machine-learning process, or other automated and computer-based process, analyzing network traffic flowing through a network or portion of a network.

At operation 304, the data packet is transmitted having the deceptive destination IP address. In some examples, the data packet is transmitted via an APN redirection capable logical communication channel, as described above. For example, the data packet may be transmitted by a transmitting device via a logical communication channel to an intermediary node with which the transmitting device has registered, or with which the transmitting device is registered, for APN redirection. In some examples, the registration of the transmitting device with the intermediary node is performed prior to the transmission of the data packet. For example, the intermediary node may assign an IP address to the transmitting device for a network in which the intermediary node resides, or another device in the network in which the intermediary node resides may assign the IP address to the transmitting device. The assigned IP address may be included in the data packet as a source IP address of the data packet. The IP address may be associated in the network in which the intermediary node resides with a unique identifier of the transmitting device, such as a media access control address, which is specified as being registered for APN redirection.

At operation 306, the data packet is received by a relay node. In some examples, the relay node is a scatter relay, as described above. The relay node receives the data packet from the intermediary node. For example, responsive to receiving the data packet having the source IP address, the intermediary node identifies the transmitting device of the data packet as being registered for APN redirection to the relay node. Responsive thereto, the intermediary node provides the data packet to the relay node and does not forward the data packet on in a network based on the deceptive destination IP address.

At operation 308, the relay node replaces the deceptive destination IP address with an actual destination IP address. In some examples, the relay node determines the actual destination IP address by searching a lookup table based on contents of the data packet, such as the source IP address, the deceptive destination IP address, and/or content(s) of a payload of the data packet. In other examples, the relay node determines the actual destination IP address based on an identifier, such as an EVT, included in the data packet. In yet other examples, the relay node determines the actual destination IP address based on any suitable content(s) of the payload of the data packet. After determining the actual destination IP address, the relay node relaces the deceptive destination IP address in the data packet.

At operation 310, responsive to replacing the destination IP address with the actual destination IP address to form a modified data packet, the relay node forwards the data packet on in the network based on the actual destination IP address. In some examples, the relay node directly forwards the modified data packet. In other examples, the relay node forwards the modified data packet by providing the modified data packet to the intermediary node for transmission by the intermediary node based on the actual destination IP address.

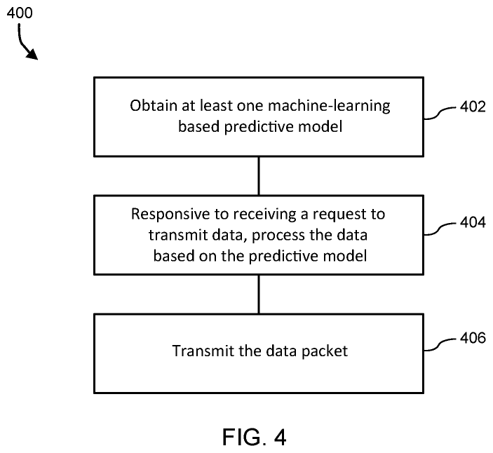

Turning now to FIG. 4, a method 400 is described. In some examples, the method 400 is a method of network traffic obfuscation. In some examples, the network traffic obfuscation is performed by at least some components of the communication system 10, such as scatter networking nodes.

At operation 402, a scatter network node obtains at least one machine-learning based predictive model. In some examples, the scatter network node obtains the predictive model from another device, such as a server or central node, that generates the predictive model(s). In other examples, the scatter network node generates the predictive model by implementing a machine-learning based analysis of network traffic in a region in which the scatter network node is located.

At operation 404, responsive to receiving a request to transmit data, the scatter network node processes the data based on the predictive model(s). In some examples, prior to processing the data based on the predictive model, the data is a result of a division of a larger unit of source data, such as a result of separating the source data to form multiple, separate pieces of data for transmission as scattered data. In some examples, processing the data includes packetizing the data. Packetizing the data may include applying a protocol header to the data and/or forming a payload based on the data. In some examples, the protocol header is a UDP header or a TCP header. In some examples, the protocol header includes an identifier of the data packet, a record type, a size or length, or the like. In other examples, packetizing the data may also include padding a length of the payload of the data packet to modify a size or length of the data packet.

At operation 406, the scatter network node transmits the data packet. In some examples, the scatter network node transmits the data packet in a communication channel and with a timing specified by the predictive model(s). For example, the predictive model(s) may specify an inter-packet timing for transmitting the data packet with respect to one or more other data packets. In some examples, the data packet may be placed in a queue and pulled from the queue for transmission based on the inter-packet timing specified by the predictive model(s). In some examples, the scatter network node transmits the data via a communication channel specified by the predictive model(s), such as a communication channel corresponding to a format according to which the predictive model packetized the data.

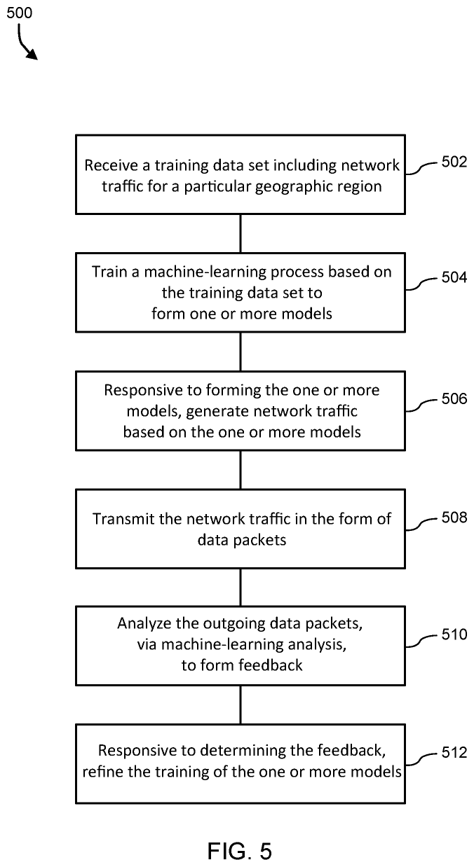

Turning now to FIG. 5, a method 500 is described. In some examples, the method 500 is a method of network traffic obfuscation. In some examples, the network traffic obfuscation is performed by at least some components of the communication system 10, such as scatter networking nodes.

At operation 502, a training data set is received. In some examples, the training data set includes network traffic for a particular geographic region. In other examples, the training data set includes network traffic having a particular protocol type, a particular data type, or any other suitable characteristic. In some examples, the training data set is received collectively, such as from a third-party, while in other examples the training data set is collected, such as through network traffic intercepts.

At operation 504, a machine-learning process is trained based on the training data set to form one or more models. In some examples, at least some of the models are predictive models. At least some of the models enable the machine-learning process to predict at least some network traffic characteristics for network traffic in the particular geographic region. For example, the predictive models may indicate types of network traffic, such as described above herein, that occur more frequently in the particular geographic region than do other types of network traffic. In addition, the predictive models may indicate for a particular type of network traffic, probable characteristics of the network traffic. In this way, the predictive models may characterize the network traffic in the particular geographic area.

A operation 506, responsive to forming the one or more models, network traffic is generated based on the one or more models. In some examples, source data is provided to the one or more models to be packetized, or formed into data packets for transmission. Based on processing performed by the machine-learning process according to the one or more models, the source data may be packetized into data packets having a network traffic type, protocol, and/or other characteristics, as described above, that are common for a geographic region in which the network traffic is originating. Thus, based on the processing performed by the machine-learning process according to the one or more models, the data packets may simulate at least some of the network traffic that occurs more frequently in the particular geographic region than does other network traffic. In this way, the processing performed by the machine-learning process according to the one or more models obfuscates the data packets, reducing a probability of an unauthorized observer determining a true nature of the data packets.

At operation 508, the data packets are transmitted. In some examples, the data packets are transmitted based on the processing performed by the machine-learning process according to the one or more models. For example, inter-packet timing between transmission of data packets, an order in which the data packets are transmitted, a logical communication channel over which the data packets are transmitted, a number of data packets transmitted in a particular communication session, or the like may be modified or controlled based on the processing performed by the machine-learning process according to the one or more models. In this way, the transmissions controlled by the machine-learning process according to the one or more models may further obfuscate the data packets, further reducing the probability of the unauthorized observer determining the true nature of the data packets.

At operation 510, the machine-learning process may analyze the outgoing data packets (e.g., the data packets being transmitted) to form feedback. For example, the machine-learning process may analyze the outgoing data to determine whether any patterns, characteristics, or other indicia exist in the outgoing data to indicate that the outgoing data is unusual, suspicious, or otherwise seemingly out of place for the geographic region from which the outgoing data is transmitted or based on contents of a header of the outgoing data.

At operation 512, responsive to determining the feedback, the machine-learning process refines the training of the one or more models. For example, the machine-learning process may retrain or modify the training of the one or more models such that, for first network traffic transmitted at a first time according to the one or more models before refining and which the machine-learning process determines unusual, suspicious, or otherwise seemingly out of place characteristics, at a second time the machine-learning process would not determine that the first network traffic transmitted at the second time according to the refined one or more models exhibits unusual, suspicious, or otherwise seemingly out of place characteristics. In this way, by examining the outgoing data, performance of the machine-learning process and the one or more models is improved through an iterative feedback and refinement process.

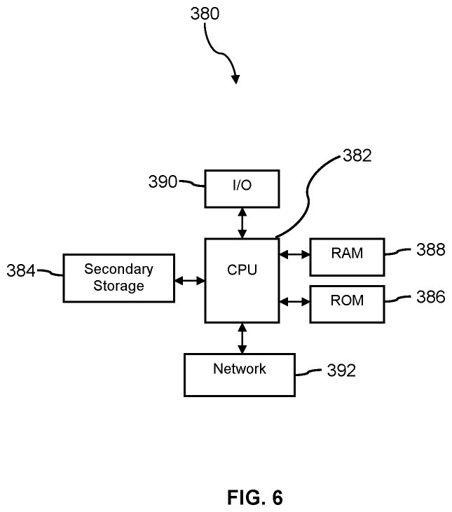

FIG. 6 illustrates a computer system 380 suitable for implementing one or more examples disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips and/or may me a multi-core processor.

By programming and/or loading executable instructions onto the computer system 380, at least one of the CPU 382, the RAM 388, and the ROM 386 are changed, transforming the computer system 380 in part into a particular machine or apparatus having the functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions which comprise the application. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that comprise the application. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the functionality taught by the present disclosure. When the CPU 382 is configured in this way by the application, the CPU 382 becomes a specific purpose computer or a specific purpose machine.

The secondary storage 384 typically comprises one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may be referred to as physical interfaces or physical network interfaces. The network connectivity devices 392 may take the form of modems, modem banks, Ethernet cards, universal serial bus (USB) interface cards, serial interfaces, token ring cards, fiber distributed data interface (FDDI) cards, WLAN cards such as a WiFi physical interface, radio transceiver cards such as a WWAN (e.g., a cellular network physical interface), and/or other network devices. A network connectivity device 392 may comprise an Ethernet-to-satellite wireless link physical interface. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an example, the radio transceiver cards may provide wireless communication links using protocols such as CDMA, GSM, LTE, WiFi (IEEE 802.11), Bluetooth, Zigbee, NB IoT, NFC, RFID. The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and transmitted to the network, for example, in the form of a computer data baseband signal or signal embodied in a carrier wave. The baseband signal or signal embedded in the carrier wave, or other types of signals currently used or hereafter developed, may be generated according to any suitable methods. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors or processor cores may be present. Thus, while instructions may be discussed as executed by a processor, the instructions may be executed simultaneously, serially, or otherwise executed by one or multiple processors or processor cores. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an example, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an example, virtualization software may be employed by the computer system 380 to provide the functionality of a number of servers that is not directly bound to the number of computers in the computer system 380. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an example, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM example of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several examples have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various examples as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A scatter network device, comprising:
a non-transitory memory;
at least one processor; and
a scatter application stored in the non-transitory memory that, when executed by the at least one processor:
receives a request to transmit source data to a destination device;
processes the source data via a predictive machine-learning model executed by the scatter application to packetize the source data into a data packet, the data packet having a format indicative of network traffic existing in a region in which the scatter network device is located and having a frequency of occurrence greater than a threshold amount, wherein the format indicative of network traffic existing in the region in which the scatter network device is located is different from a format of the source data; and
transmits the data packet.

2. The scatter network device of claim 1, wherein the data packet includes at least a source Internet Protocol (IP) address identifying the scatter network device, a destination IP address, and a payload, the payload including at least a protocol header and a portion of the source data.

3. The scatter network device of claim 2, wherein the protocol header has a format determined according to the predictive machine-learning model.

4. The scatter network device of claim 2, wherein the predictive machine-learning model is configured to determine the protocol header such that the protocol header mimics the network traffic existing in the region in which the scatter network device is located and having a frequency of occurrence greater than the threshold amount.

5. The scatter network device of claim 4, wherein the predictive machine-learning model is configured to:
determine an IP address of a network device to which network traffic having the protocol header is transmitted at a frequency greater than a second threshold amount, the IP address not of the destination device; and
provide the IP address of the network device as the destination IP address in the data packet.

6. The scatter network device of claim 2, wherein the predictive machine-learning model is configured to control an inter-packet timing of the transmitting to mimic the network traffic existing in the region in which the scatter network device is located and having a frequency of occurrence greater than the threshold amount.

7. The scatter network device of claim 2, wherein the predictive machine-learning model is configured to control a size of the data packet to mimic the network traffic existing in the region in which the scatter network device is located and having a frequency of occurrence greater than the threshold amount.

8. The scatter network device of claim 2, wherein the predictive machine-learning model is configured to control a record type indicated in the protocol header to mimic the network traffic existing in the region in which the scatter network device is located and having a frequency of occurrence greater than the threshold amount, the record type not indicative of the source data.

9. The scatter network device of claim 2, wherein the predictive machine-learning model is configured to control a communication channel, from among a plurality of available communication channels, on which the transmitting is performed to mimic the network traffic existing in the region in which the scatter network device is located and having a frequency of occurrence greater than the threshold amount.

10. A method, comprising:
receiving a training data set, the training data set including network traffic for a geographic region;
training a machine-learning model by characterizing, via a machine-learning analysis, the geographic region based on the training data set to determine first network traffic characteristics occurring in the geographic region at a frequency greater than second network characteristics;
receiving a data packet packetized according to the machine-learning model;
analyzing the data packet to determine whether the data packet exhibits suspicious characteristics, the analysis resulting in data packet feedback; and
refining the machine-learning model based on the data packet feedback.

11. The method of claim 10, further comprising generating a header of the data packet according to the machine-learning model.

12. The method of claim 11, further comprising generating a second header of a second data packet according to the machine-learning model after the refining, wherein the refining causes the header of the second data packet to include different network characteristics than included in the header of the data packet.

13. The method of claim 10, wherein the characterizing includes at least data packet size, inter-packet timing, data packet record type, data packet request-reply pairs, timing between data packet request-reply pairs, bandwidth, time of network traffic transmission, destination of network traffic transmission, and communication session length.

14. A method, comprising:
receiving, at a scatter network device, a request to transmit source data from a source device to a destination device;
forming a data packet including at least a source Internet Protocol (IP) address identifying the scatter network device, a deceptive destination IP address not identifying the destination device, and a payload, the payload including at least a portion of the source data, wherein the deceptive destination IP address identifies a network destination determined to receive a volume of communication greater than a threshold amount from a region in which the scatter network device is located; and
transmitting the data packet having the deceptive destination IP address in a network.

15. The method of claim 14, further comprising:
receiving, in the network, the data packet at a scatter relay node;
determining, based on the payload of the data packet, an actual destination IP address of the destination device;
replacing the deceptive destination IP address in the data packet with the actual destination IP address; and
transmitting the data packet having the actual destination IP address in the network.

16. The method of claim 15, wherein the scatter relay node receives the data packet from a mobile network operator in a cellular communication network.

17. The method of claim 15, wherein the scatter relay node receives the data packet from a ground handoff station in a satellite communication network.

18. The method of claim 15, further comprising determining the actual destination IP address based on an endpoint validation token included in the payload and identifying the destination device.

19. The method of claim 15, further comprising registering, with a network relay node in the network, an association between the source IP address and a unique identifier of the scatter network device, the registration indicating that network traffic originating in the network at the scatter network device should be handled according to Access Point Name (APN) redirection.

20. The method of claim 14, further comprising:
performing a machine-learning analysis of training data to determine a plurality of network destinations determined to receive the volume of communication greater than the threshold amount from the region in which the scatter network device is located, the plurality of network destinations including at least the network destination, and the training data including network traffic in the region in which the scatter network device is located; and
selecting, from among the plurality of network destinations, the network destination.
